(19) United States
(12) Patent Application Publication
(10) Pub. No.: US 2018/0354554 A1
(43) Pub. Date: Dec. 13, 2018

(54) METHODS AND SYSTEMS FOR MOTOR VEHICLE PARKING ASSISTANCE

(71) Applicant: GM GLOBAL TECHNOLOGY OPERATIONS LLC, Detroit, MI (US)

(72) Inventors: SEYEDALIREZA KASAIEZADEH MAHABADI, SHELBY TOWNSHIP, MI (US); MOHAMMAD NASERIAN, WINDSOR (CA); BAKHTIAR B. LITKOUHI, WASHINGTON, MI (US)

(73) Assignee: GM GLOBAL TECHNOLOGY OPERATIONS LLC, Detroit, MI (US)

(21) Appl. No.: 15/616,801

(22) Filed: Jun. 7, 2017

(51) Int. Cl. B62D 15/02; B60R 1/00

(52) U.S. Cl. CPC B62D 15/028; B60R 1/00; B60R 2300/105; B60R 2300/806; B60K 2350/1088; B60K 2350/2013; B60K 2350/1028; B60K 2350/106; B60R 2300/303

(57) ABSTRACT

Methods and motor vehicles that assist a driver are provided. In an exemplary embodiment, a method includes identifying one or more potential parking positions for a motor vehicle. Selection of a desired parking position is requested, and a suggested driving path for positioning the motor vehicle in the desired parking position is calculated. The suggested driving path is displayed to the driver on a display screen, and the suggested driving path is re-calculated as the driver drives the motor vehicle with a steering wheel. The display screen is updated with the suggested driving path after the suggested driving path is re-calculated and as the driver drives the motor vehicle with the steering wheel.

### INTRODUCTION

The technical field generally relates to methods and systems for motor vehicle parking assistance, and more particularly relates to methods and systems for motor vehicle parking assistance with a trailer.

Backing a motor vehicle with a trailer is a challenging task, especially for inexperienced drivers. Turning the steering wheel to the left turns the trailer to the right, and the trailer seems to turn differently depending on the position of the trailer behind the motor vehicle. A driver often backs up, realizes the position is not proper, and repeatedly pulls forward to try again. Trailing backing with a knob instead of the steering wheel has been tried, but many find the knob to be less than ideal. Furthermore, the driver does not gain experience backing a trailer with a steering wheel, in the traditional sense, when using the knob.

Accordingly, it is desirable to provide methods and systems for advising a driver on backing a trailer while leaving driving control with the driver. In addition, it is desirable to provide methods and systems for backing a trailer that provide real world experience to the driver in backing a trailer. Furthermore, other desirable features and characteristics will become apparent from the subsequent detailed description and the appended claims, taken in conjunction with the accompanying drawings and background.

### SUMMARY

Methods and motor vehicles that assist a driver are provided. In an exemplary embodiment, a method includes identifying one or more potential parking positions for a motor vehicle. Selection of a desired parking position is requested, and a suggested driving path for positioning the motor vehicle in the desired parking position is calculated. The suggested driving path is displayed to the driver on a display screen, and the suggested driving path is re-calculated as the driver drives the motor vehicle with a steering wheel. The display screen is updated with the suggested driving path after the suggested driving path is re-calculated and as the driver drives the motor vehicle with the steering wheel.

A motor vehicle is provided in another embodiment. The motor vehicle includes a detector within the motor vehicle, where the detector is configured to detect features outside of the motor vehicle. A parking advisor controller is within the motor vehicle and in communication with the detector, where the parking advisor controller is configured to perform several tasks, including: (1) identify one or more potential parking positions for the motor vehicle; (2) request a driver to select a desired parking position; (3) calculate a suggested driving path for positioning the motor vehicle in the desired parking position; (4) display the suggested driving path to the driver on a display screen; (5) re-calculate the suggested driving path as the motor vehicle moves; and (6) update the display of the suggested driving path after the suggested driving path is re-calculated. A steering wheel is configured to steer the motor vehicle, where the steering wheel is further configured for manual control.

A method of assisting a driver is provided in yet another embodiment. The method includes saving a desired parking position for a motor vehicle in a parking advisor memory, and requesting a selection of the desired parking position from the parking advisor memory. A suggested driving path for positioning the motor vehicle in the desired parking position is calculated and displayed to the driver on a display screen. The suggested driving path is re-calculated and then updated on the display screen as the driver drives the motor vehicle with a steering wheel.

### BRIEF DESCRIPTION OF THE DRAWINGS

The exemplary embodiments will hereinafter be described in conjunction with the following drawing figures, wherein like numerals denote like elements, and wherein:

FIG. 1 illustrates an exemplary motor vehicle and trailer;

FIG. 2 is a schematic drawing of a detector controller, a parking advisor controller, and a display screen;

FIG. 3 is a flow sheet of an embodiment of a parking assistance protocol;

FIGS. 5-9 are views of various embodiments of the display screen.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

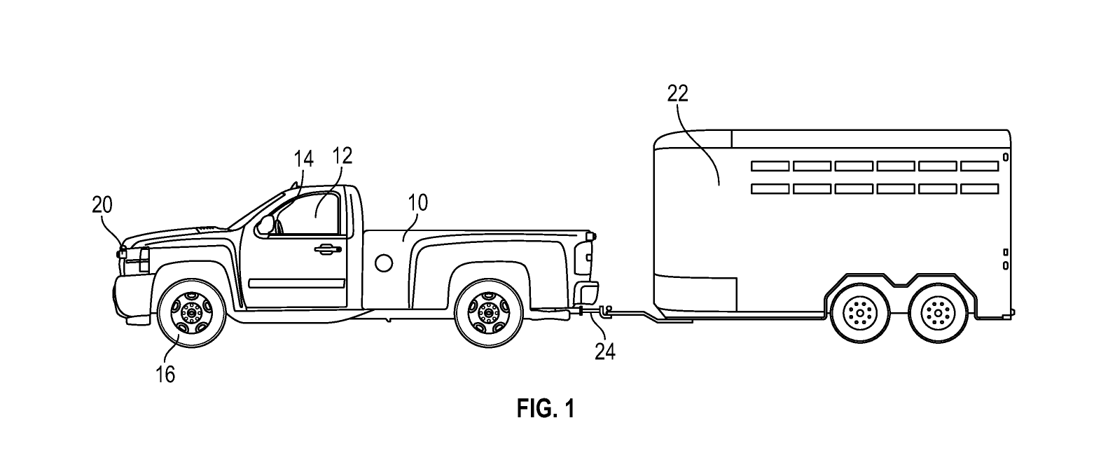

Reference is made to an exemplary embodiment in FIG. 1. A motor vehicle 10 is provided, wherein the motor vehicle 10 has a cabin 12 configured for occupation by people. In an exemplary embodiment, the motor vehicle 10 is an automobile, such as a pickup truck, a van, or a car. The cabin 12 includes a steering wheel 14 configured for steering the motor vehicle 10 using manual control. “Manual control,” as used herein, indicates the steering wheel 14 is turned manually even though the turning motion may be assisted, such as with power steering. As such, there is no motor that turns the steering wheel 14 without a person or other force that is not a part of the motor vehicle 10 turning the steering wheel 14. In some embodiments, the steering wheel 14 is configured for manual control at all times. The steering wheel 14 is coupled to a turning wheel 16 of the motor vehicle 10, such that when the steering wheel 14 is turned the turning wheel 16 turns. In an exemplary embodiment, the turning wheel(s) 16 are the two front wheels of the motor vehicle 10, but in alternate embodiments the turning wheel 16 is a single front wheel (in embodiments with only 1 front wheel), or two back wheels, or a single back wheel in embodiments with only 1 back wheel. Other embodiments are also possible. The direction of travel of the motor vehicle 10 is generally controlled by the turning wheel 16, which is controlled in turn by the steering wheel 14.

The motor vehicle 10 includes one or more detectors 20 in an exemplary embodiment, where the detectors 20 provide a 360-degree view around the motor vehicle 10. The 360-degree view is generally horizontal about the motor vehicle 10, but the view includes some vertical aspects as well in many embodiments. In an exemplary embodiment, the detectors 20 are cameras, but in alternate embodiments the detector(s) 20 are one or more of a camera, an infrared detector, a radar, an ultrasound detector, or other detectors. The detector(s) 20 are configured to detect objects near the motor vehicle 10, such as pedestrians, other motor vehicles, curbs, trees, signs, etc.

A trailer 22 is connected to the motor vehicle 10 in an exemplary embodiment. The trailer 22 is connected to the motor vehicle 10 at a hitch 24, where the hitch 24 is located at or near a rear bumper of the motor vehicle 10 in an exemplary embodiment. The hitch 24 is located within a pickup truck bed in an alternative embodiment (not illustrated), and the trailer 22 is a goose-neck trailer. The hitch 24 provides a pivoting connection, such that the trailer 22 and motor vehicle 10 are capable of pivoting relative to each other at the hitch 24. Several different trailer sizes and styles are available, and a single motor vehicle 10 may be used to pull different trailers 22 at different times. A trailer data set defines the design of the trailer 22, and the trailer data set is communicated to the motor vehicle 10 in an exemplary embodiment. For example, the trailer data set includes a total trailer length, a trailer tongue length, a trailer axel number, a trailer axel position, a trailer width, a trailer connection style (goose-neck, bumper hitch, etc.), and other details regarding the trailer 22. The trailer data set is manually communicated with the motor vehicle 10 in an exemplary embodiment, as described more fully below, but in alternate embodiments the trailer data set is automatically communicated to the motor vehicle 10, such as through a wireless communication or by an electrical connection made when the trailer 22 is electrically connected to the motor vehicle 10. The trailer data set is used to calculate the motion of the trailer as the motor vehicle 10 moves, as explained more fully below.

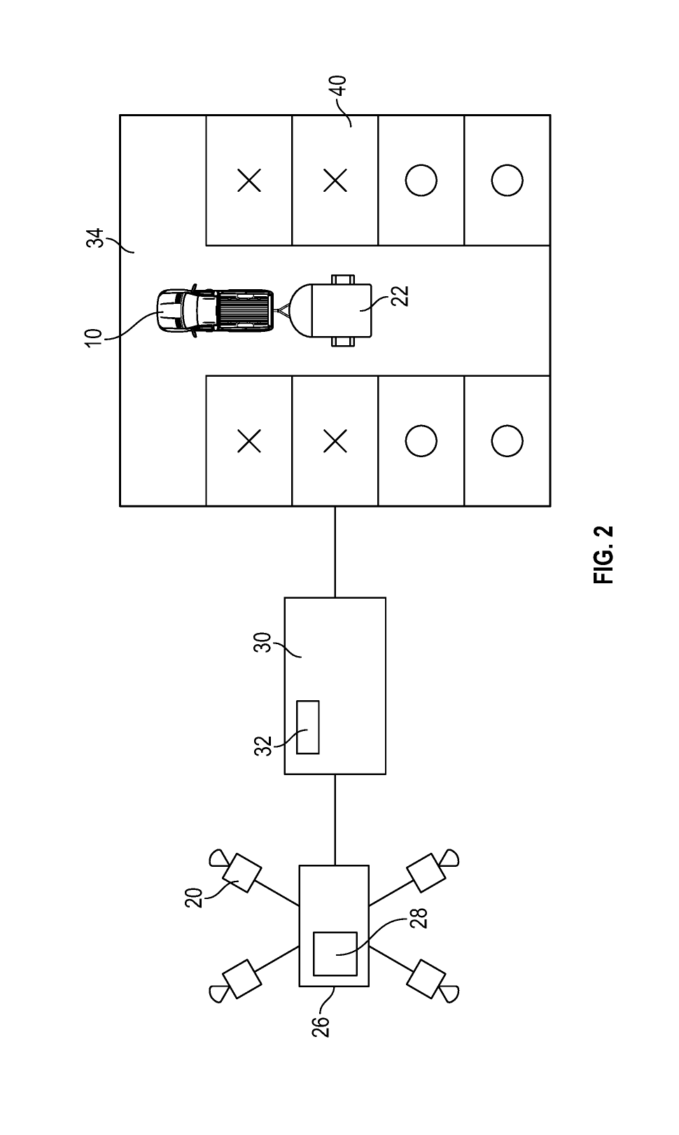

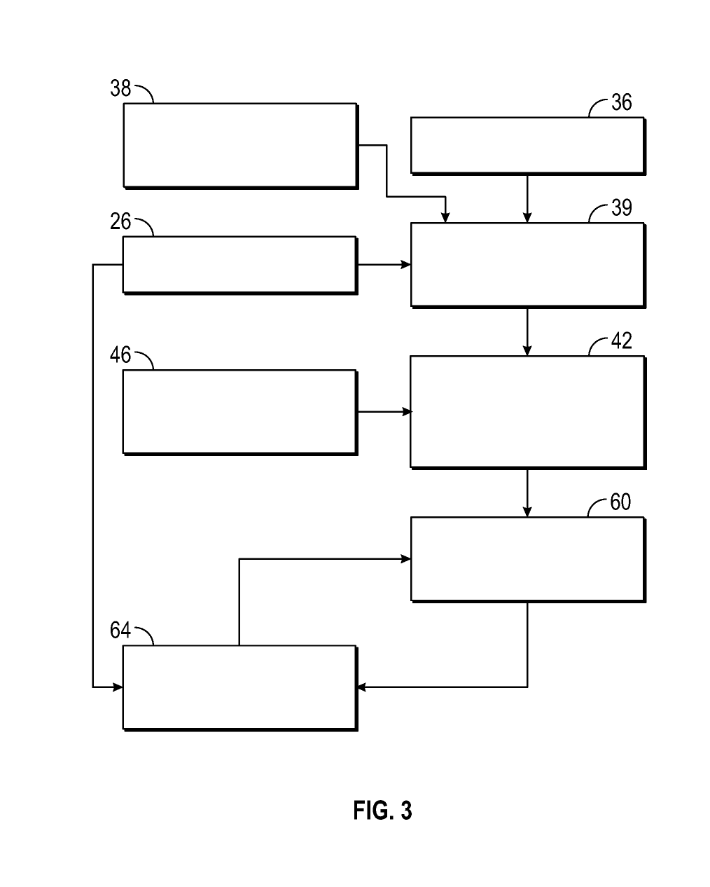

Referring to FIG. 2, with continuing reference to FIG. 1, the detectors 20 are 4 cameras mounted at corners of the motor vehicle 10 in an exemplary embodiment. The detectors 20 are in communication with a detector controller 26, where the detector controller 26 analyzes signals from the detectors 20 to determine the position of objects near the motor vehicle 10. In various embodiments, the detector controller 26 includes any type of processor or multiple processors, integrated circuits such as a microprocessor, or any suitable number of integrated circuit devices and/or circuitry working in cooperation to accomplish the tasks of the detector controller 26. The detector controller 26 executes one or more programs that are stored within a detector controller memory 28 in an exemplary embodiment. In one example, the detector controller memory 28 saves various other data as well, such as information for other processes within the motor vehicle 10. In various embodiments, the detector controller 26 includes, or has access to, any type of detector controller memory 28, including but not limited to random access memory (RAM), read only memory (ROM), erasable programmable read only memory (EPROM), electrically erasable programmable read only memory (EEPROM), and non-volatile random access memory (NVRAM).

The detector controller 26 communicates with a parking advisor controller 30 in an exemplary embodiment, so the detector(s) 20 are in communication with the parking advisor controller 30 through the detector controller 26. As with the detector controller 26, the parking advisor controller 20 includes any type of processor or multiple processors, integrated circuits such as a microprocessor, or any suitable number of integrated circuit devices and/or circuitry working in cooperation to accomplish the tasks of the parking advisor controller 30. The parking advisor controller 30 also executes one or more programs that are stored within a parking advisor memory 32 in an exemplary embodiment, where the parking advisor memory 32 is similar to the detector controller memory 28 described above. In an alternate embodiment, the detector controller 26 and the parking advisor controller 30 are combined in a single processor, computer, integrated circuit, comparable circuitry, or combination thereof, but are still described herein as separate components based on the different functionality. The parking advisor controller 30 is in communication with a display screen 34 in an exemplary embodiment. The detector controller 26 and/or the parking advisor controller 30 are optionally combined with other controllers in the motor vehicle 10 or are separate units in various embodiments.

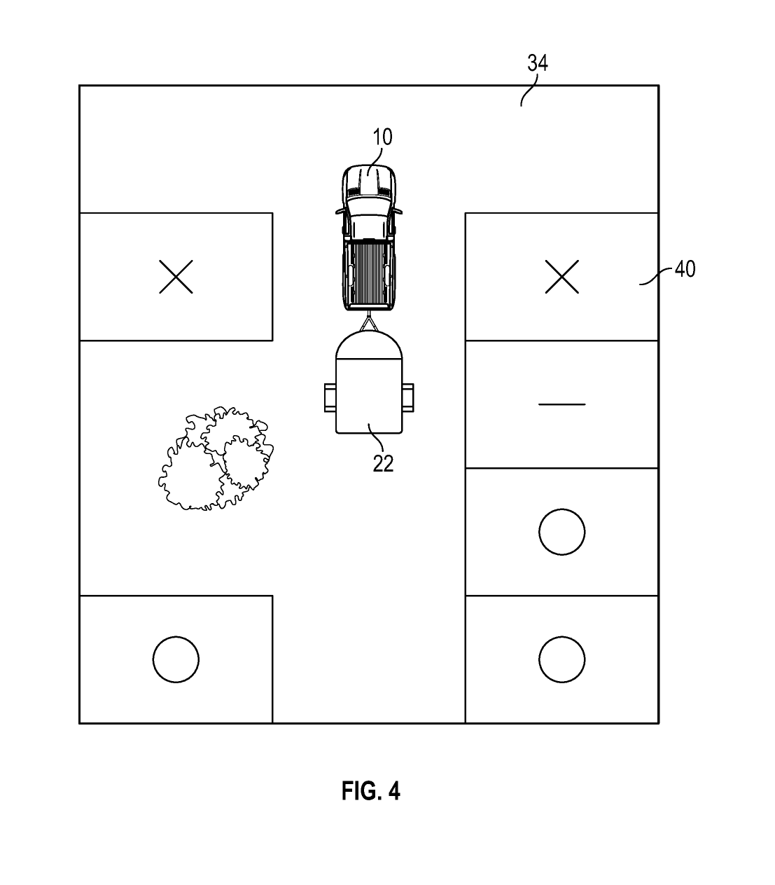

The parking advisor controller 30 provides parking advice to a driver of the motor vehicle 10 using a protocol, as illustrated in an exemplary embodiment in FIG. 3 with continuing reference to FIGS. 1 and 2. Activation 36 of the parking advisor controller 30 begins the process. The parking advisor controller 30 is activated by the driver, and a variety of techniques for the activation 36 are possible. For example, activation 36 is initiated by touching an activation area of the display screen 34 in one embodiment, but a toggle switch, a button, a voice command, or other techniques are used in alternate embodiments. In an exemplary embodiment, if the parking advisor controller 30 is not activated, no advice is given to the driver for backing or parking. The parking advisor controller 30 is configured to perform at least the tasks illustrated in FIG. 3 and as described below.

Trailer data entry 38 provides the trailer data set to the parking advisor controller 30. Trailer data entry 38 is manual in an exemplary embodiment, where each piece of information of the trailer data set is individually entered into the parking advisor controller 30 and saved in the parking advisor memory 32. The display screen 34 is used to enter the trailer data set in an exemplary embodiment, and the trailer data set is saved with a trailer name in the parking advisor memory 32 for future reference. In alternate embodiments, the trailer 22 includes a bar code, a memory chip, or other data storage (not illustrated) that includes the trailer data set, and the motor vehicle 10 includes a reader (not illustrated) for retrieving the trailer data set. Different trailer data sets are associated with different trailers 22, so trailer data entry 38 is individually used and saved for each trailer 22 pulled by the motor vehicle 10.

Upon activation 36, the detector(s) 20 scan the area near the motor vehicle 10 and identify the location of objects and open areas. The parking advisor controller 30 identifies 39 one or more potential parking positions 40. The parking advisor controller 30 then requests 42 selection of a desired parking position 48. In an exemplary embodiment, the parking advisor controller 30 illustrates the potential parking positions 40 on the display screen 34, as seen in FIG. 4 with continuing reference to FIGS. 1-3. The parking advisor controller 30 illustrates all potential parking positions 40 in an exemplary embodiment, where colors or symbols are included to indicate potential parking positions 40 that are not accessible from the current position of the motor vehicle 10, potential parking positions 40 that are accessible from the current position of the motor vehicle 10, and optionally identifies 39 potential parking positions 40 that are possible but difficult to access from the current position of the motor vehicle 10. FIG. 4 illustrates available potential parking positions 40 with an “O”, inaccessible potential parking positions 40 with an “X”, and difficult to access potential parking positions 40 with a “-”, but other symbols, colors, or indicia are used in alternate embodiments. FIG. 4 also illustrates the position of an object, which is a tree 44 in the illustrated embodiment, for the driver to consider.

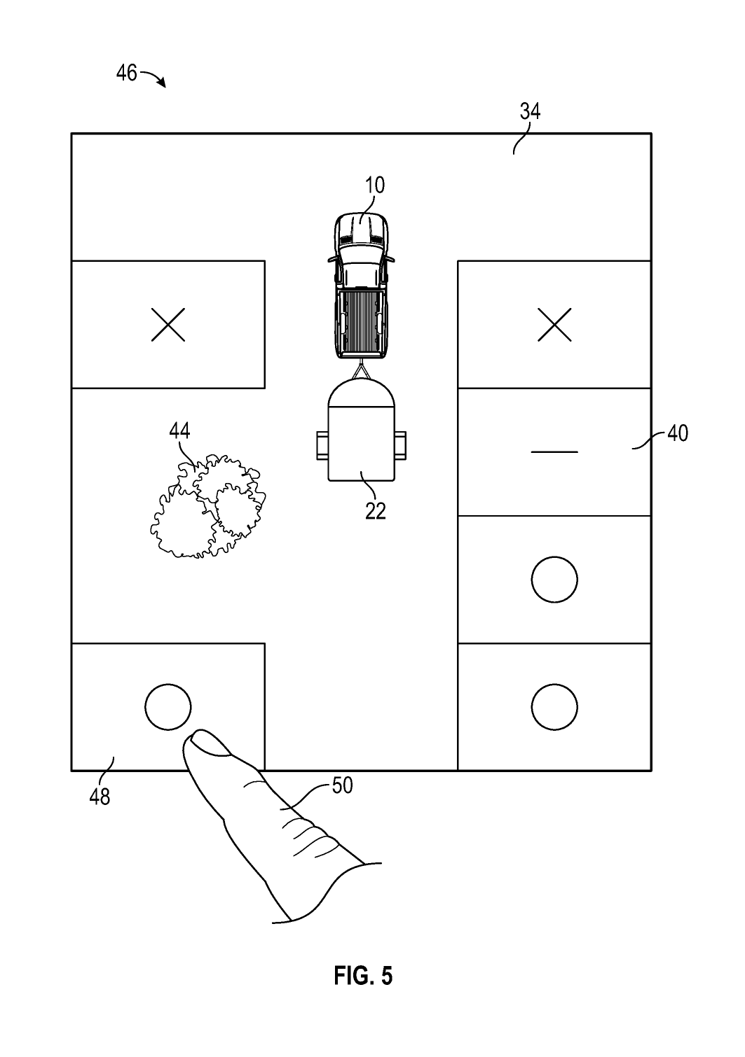

The driver or other human selects 46 the desired parking position 48, as illustrated in FIG. 5 with continuing reference to FIGS. 1-2. In the illustrated exemplary embodiment, the driver selects 46 the desired parking position 48 by touching the desired parking position 48 on the display screen 34, such as with a finger 50. In an exemplary embodiment, the driver or other person also selects 46 a parking orientation when selecting 46 the desired parking position 48, such as by dragging the finger 48 into the desired parking position to indicate the trailer 22 and motor vehicle 10 position within the desired parking position. In an alternate embodiment, the driver or other person selects 46 the orientation by touching the desired parking position 48 two times, once for a back end of the trailer 22 and another time to establish a center line of the trailer 22. Other techniques for selecting the desired parking position 48 and optionally the orientation within the desired parking position 48 are possible in alternate embodiments.

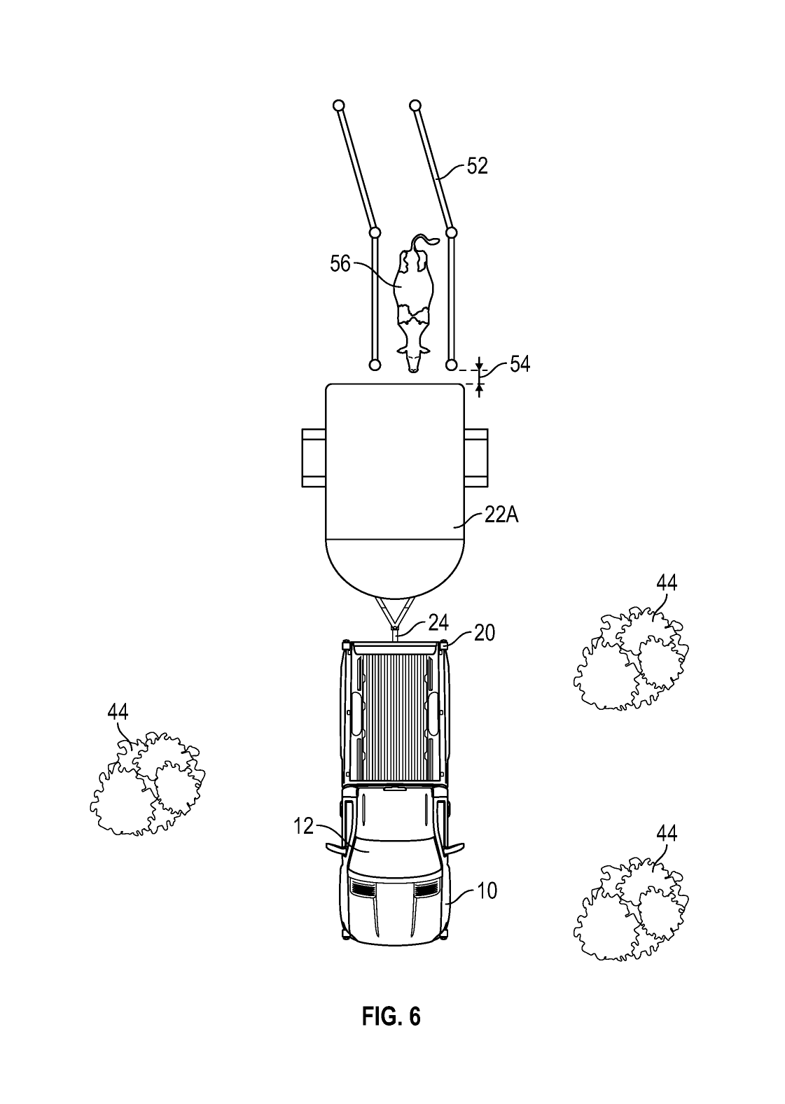

An alternate embodiment for selecting 46 the desired parking position 48 is illustrated in FIG. 6, with continuing reference to FIGS. 1-3. The motor vehicle 10 saves a desired parking position 48 in the parking advisor memory 32, and the driver selects 46 the desired parking position 48 from those saved in the parking advisor memory 32. The parking advisor controller 30 requests 42 the driver to select 46 the desired parking position 48 from the desired parking positions 48 saved in the parking advisor memory 32. The request 42 is made from the display screen 34 in an exemplary embodiment, but other techniques for selecting the saved desired parking position 48 are also available, such as toggle switches, voice commands, etc. The parking advisor controller 30 recalls the position of nearby objects from the parking advisor memory 32, which are trees 44 in FIG. 6, and uses the objects (trees 44) as reference points to determine the exact location and optionally alignment for the desired parking position 48. The parking advisor controller 30 finds the position of the desired parking position 48 and the motor vehicle 10 by triangulating with the objects (trees 44) in an exemplary embodiment. Several parking positions are saved in various embodiments, such as within a storage shed for the trailer 22, a boat launch area, etc. In the embodiment illustrated in FIG. 6, the trailer 22 is a cattle trailer 22A that is parked at the opening of a cattle chute 52, where the cattle trailer 22A is properly aligned and positioned such that a gap 54 between the cattle trailer 22A and the chute 52 is small enough that the cattle 56 cannot escape. The detectors 20 determine the position of nearby trees 44 or other objects, and the desired parking position 48 is determined by triangulating from the known objects. Therefore, the cattle trailer 22A is properly positioned every time cattle 56 are loaded or unloaded.

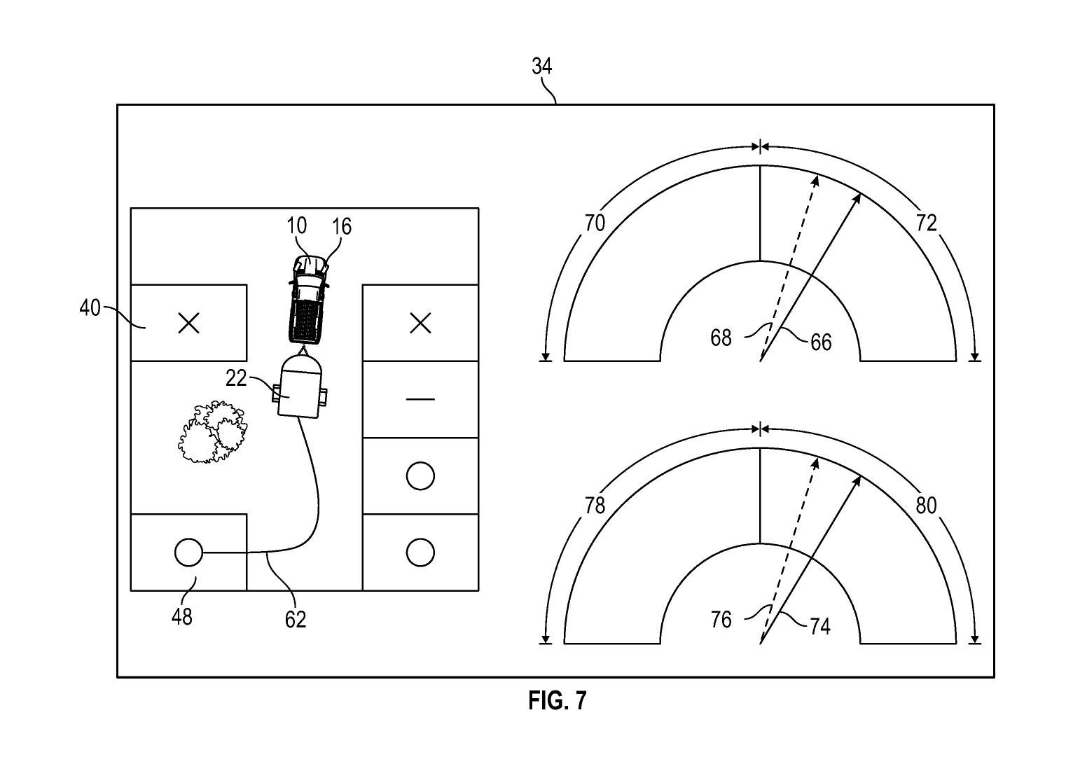

Referring to FIGS. 3 and 7, with continuing reference to FIGS. 1-2, the parking advisor controller 30 calculates 60 a suggested driving path 62 to back the trailer 22 into the desired parking position 48. The trailer data set is used in an algorithm that determines the proper position of the turning wheels 16 for backing the trailer 22. The parking advisor controller 30 then displays 64 the suggested driving path 62, such as on the display screen 34. The parking advisor controller 30 also displays a suggested steering wheel position 66 and an actual steering wheel position 68 to aid the driver in backing the trailer 22. The suggested and actual steering wheel position 66, 68 includes a left direction 70 and a right direction 72 in the illustrated embodiment. The parking advisor controller 30 displays a suggested driving speed 74 and an actual driving speed 76 in an exemplary embodiment, where the suggested driving speed 74 includes a forward direction 78 and a backward direction 80. The forward direction 78 aids in re-positioning the motor vehicle 10 to facilitate parking in potential parking positions 40 that were not accessible if the motor vehicle 10 was limited to backwards motion.

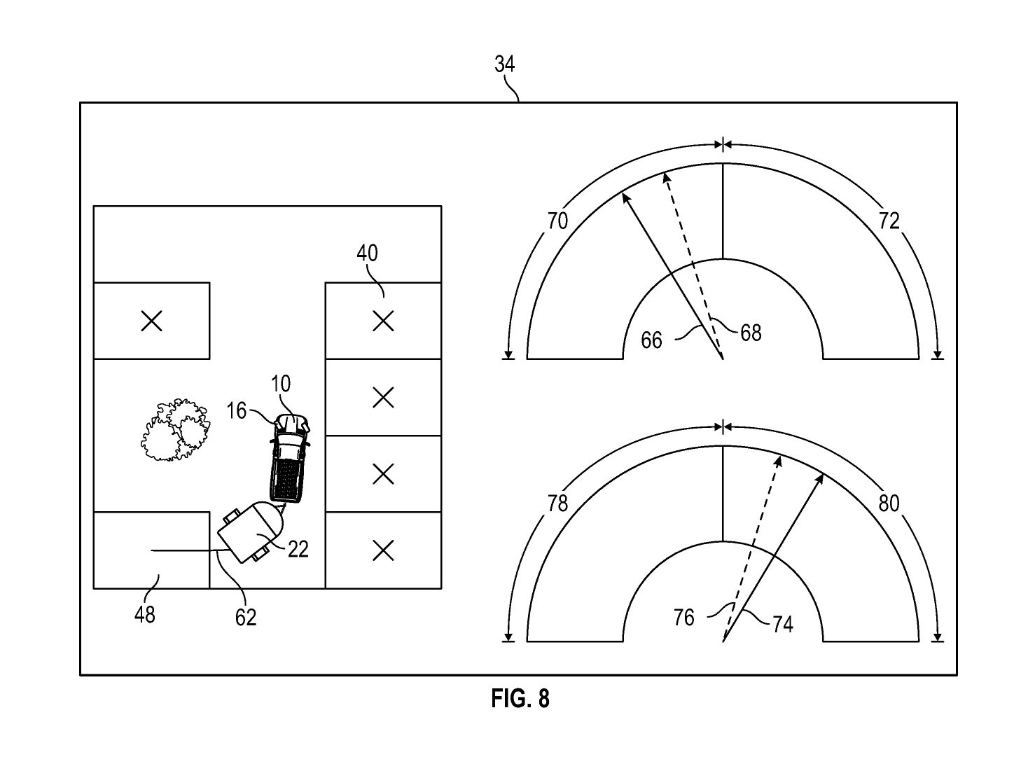

As the driver backs the trailer 22, the parking advisor controller 30 re-calculates 60 the suggested driving path 62 such that backing corrections are properly calculated and displayed, as illustrated in FIG. 8 with continuing reference to FIGS. 7 and 1-3. The display screen 34 illustrates an updated position of the motor vehicle 10 and/or trailer 22 as the motor vehicle 10 and trailer 22 move, as well as an updated suggested driving path 62, suggested and actual steering wheel positions 66, 68, and optionally suggested and actual driving speeds 74, 76. The parking advisor controller 30 continually re-calculates 60 and re-displays as the trailer 22 is backed into the desired parking position 48. The re-calculation 60 of the suggested driving path 62 is especially useful when the driver fails to follow the original suggested driving path 62 perfectly.

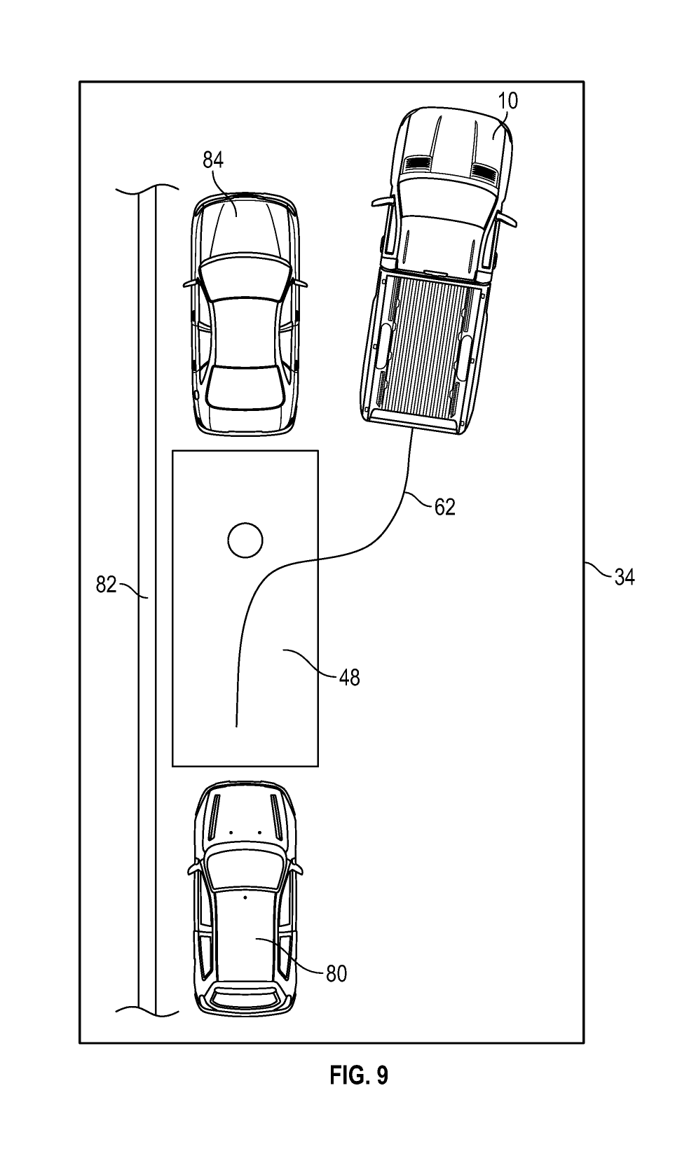

An alternate embodiment is illustrated in FIG. 9, with continuing reference to FIGS. 2 and 3, where the motor vehicle 10 is being parallel parked and no trailer 22 is present. The desired parking position 48 is adjacent to a curb 82 and between a first parked vehicle 84 and a second parked vehicle 86. The display screen 34 and advisory protocol used to aid in backing the trailer 22 aids the driver in parallel parking without a trailer 22. The advisory protocol includes zero values for the trailer data set in an exemplary embodiment, but in an alternate embodiment the advisory protocol uses a different backing algorithm for embodiments without a trailer 22. As can be imagined, other difficult parking situations can also be included in the advisory protocol using the parking advisor controller 30, such as parking in narrow parking spaces, crowded parking lots, etc.

The motor vehicle parking assistance systems and methods described above do not take control of the steering wheel 14, so the driver gains experience and develops parking skills that are not developed by automatic parking systems. The motor vehicle parking assistance systems and methods described above are only used when activated 36 by the driver, so the driver has the option of not using the system if the driver has sufficient confidence in their parking ability.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the described embodiments in any way. Rather, the foregoing detailed description will provide those skilled in the art with a convenient road map for implementing one or more exemplary aspects. It being understood that various changes may be made in the function and arrangement of elements described in an exemplary aspect without departing from the scope of the described embodiments as set forth in the appended claims.

1. A method of assisting a driver comprising:
identifying more than one potential parking positions for a motor vehicle;
requesting a human to make a selection of a desired parking position;
calculating a suggested driving path for positioning the motor vehicle in the desired parking position after the desired parking position is selected by the human;
displaying the suggested driving path to the driver on a display screen;
re-calculating the suggested driving path as the driver drives the motor vehicle with a steering wheel; and
updating the display screen with the suggested driving path after the suggested driving path is re-calculated and as the driver drives the motor vehicle with the steering wheel.

2. The method of claim 1 wherein:
identifying more than one potential parking positions comprises identifying more than one potential parking positions for the motor vehicle and a trailer, wherein the trailer is connected to the motor vehicle, and wherein;
re-calculating the suggested driving path comprises re-calculating the suggested driving path as the driver drives the motor vehicle and the trailer with the steering wheel.

3. The method of claim 2 further comprising:
requesting a trailer data set for the trailer, wherein the trailer data set comprises information about the trailer used for calculating the suggested driving path.

4. The method of claim 1 wherein:
identifying more than one potential parking positions comprises identifying more than one potential parking positions with a parking advisor controller, wherein the parking advisor controller comprises an integrated circuit.

5. The method of claim 1 further comprising:
saving a desired parking position for a motor vehicle in a parking advisor memory.

6. The method of claim 5 wherein requesting the selection of the desired parking position comprises requesting the selection of the desired parking position from the parking advisory memory.

7. The method of claim 1 wherein displaying the suggested driving path comprises displaying the suggested driving path with an image that comprises the motor vehicle, the desired parking position, and a line, wherein the line indicates the suggested driving path.

8. The method of claim 1 wherein displaying the suggested driving path comprises displaying a suggested driving speed.

9. The method of claim 8 wherein displaying the suggested driving speed comprises displaying a suggested driving direction, wherein the suggested driving direction comprises backward or forward.

10. The method of claim 1 wherein updating the display screen comprises updating the display screen as the driver drives the motor vehicle with the steering wheel, wherein the steering wheel is configured for manual control at all times.

11. The method of claim 1 further comprising:
activating a parking advisor controller prior to identifying one or more potential parking positions.

12. The method of claim 1 wherein:
displaying the suggested driving path comprises displaying a suggested steering wheel position.

13. The method of claim 12 further comprising:
displaying an actual steering wheel position with the suggested steering wheel position.

14. The method of claim 1 wherein:
requesting the selection of the desired parking position comprises requesting the selection of a desired parking orientation.

15. A motor vehicle comprising:
a detector within the motor vehicle, wherein the detector is configured to detect features outside of the motor vehicle;
a parking advisor controller in communication with the detector, wherein the parking advisor controller is within the motor vehicle, and wherein the parking advisor controller is configured to:
identify more than one potential parking positions for the motor vehicle;
request a driver to select a desired parking position, wherein the driver is a human;
calculate a suggested driving path for positioning the motor vehicle in the desired parking position after the desired parking position is selected by the driver;
display the suggested driving path to the driver on a display screen;
re-calculate the suggested driving path as the motor vehicle changes position; and
update the display of the suggested driving path after the suggested driving path is re-calculated; and
a steering wheel configured to steer the motor vehicle, wherein the steering wheel is configured for manual control.

16. The motor vehicle of claim 15 wherein:
the parking advisor controller is configured to save a desired parking position in a parking advisor memory.

17. The motor vehicle of claim 15 wherein:
the parking advisor controller is configured to:
identify the more than one potential parking positions for the motor vehicle and for a trailer connected to the motor vehicle; and
calculate the suggested driving path for the motor vehicle and the trailer connected to the motor vehicle.

18. The motor vehicle of claim 15 wherein:
the parking advisor controller is configured to request a desired parking orientation from the driver.

19. The motor vehicle of claim 15 wherein:
the parking advisor controller is configured to display a suggested driving speed, wherein the suggested driving speed comprises a suggested driving direction, and wherein the suggested driving direction comprises forward and backward.

20. A method of assisting a driver comprising:
saving a desired parking position for a motor vehicle in a parking advisor memory;
requesting a selection of the desired parking position from the parking advisor memory;
calculating a suggested driving path for positioning the motor vehicle in the desired parking position after the desired parking position is selected by a human;
displaying the suggested driving path to the driver on a display screen;
recalculating the suggested driving path as the driver drives the motor vehicle with a steering wheel; and
updating the display screen with the suggested driving path as the driver drives the motor vehicle with the steering wheel.
